(19) United States
(12) Patent Application Publication
(10) Pub. No.: US 2025/0183389 A1
(43) Pub. Date: Jun. 5, 2025

(54) ELECTRIC CIRCUIT AND STORAGE MEDIUM

(71) Applicant: TOYOTA JIDOSHA KABUSHIKI KAISHA, Toyota-shi (JP)

(72) Inventors: Jinwoo KIM, Toyota-shi (JP); Fumiyoshi Kuribara, Toyota-shi (JP)

(73) Assignee: TOYOTA JIDOSHA KABUSHIKI KAISHA, Toyota-shi (JP)

(21) Appl. No.: 18/792,805

(22) Filed: Aug. 2, 2024

(30) Foreign Application Priority Data
Dec. 4, 2023 (JP) 2023-204534

(51) Int. Cl. H01M 10/44; B60L 53/22; H01M 10/48

(52) U.S. Cl. CPC H01M 10/441; B60L 53/22; H01M 10/482; B60L 2210/40

(57) ABSTRACT

An electric circuit mounted on a vehicle includes a first battery, a second battery, a three-phase motor, an inverter circuit, a charging socket, a connection switching circuit, and a control circuit. The control circuit selectively executes the step-down charging operation and the direct charging operation such that, when the deterioration determination process determines that there is no deterioration, the step-down charging operation is executed when the output voltage difference is larger than the reference value and the direct charging operation is executed when the output voltage difference is smaller than the reference value. When it is determined that there is deterioration in the deterioration determination process, the control circuit executes the step-down charging operation regardless of the output voltage difference.

### CROSS-REFERENCE TO RELATED APPLICATION

This application claims priority to Japanese Patent Application No. 2023-204534 filed on Dec. 4, 2023, incorporated herein by reference in its entirety.

### BACKGROUND

### 1. Technical Field

The technology disclosed herein relates to an electric circuit and a storage medium.

### 2. Description of Related Art

Japanese Unexamined Patent Application Publication No. 2020-120566 (JP 2020-120566 A) discloses an electric circuit mounted on a vehicle. This electric circuit includes a series circuit of two batteries, an inverter circuit, and a three-phase motor. The inverter circuit drives the three-phase motor by converting direct current (DC) power supplied from the series circuit of batteries into alternating current (AC) power and supplying the AC power to the three-phase motor. The electric circuit also includes wiring that connects a connection point of the two batteries and a neutral point of coils of the three-phase motor. By transferring power between the two batteries via the wiring, the temperature of each battery can be increased.

### SUMMARY

For an electric circuit that includes two batteries, an inverter circuit, and a three-phase motor, there is a technique of connecting a charging facility external to a vehicle to the electric circuit to charge each battery. One of the batteries is connected to the charging facility via a wiring. The other battery is connected to the charging facility via the inverter circuit and the three-phase motor. According to this configuration, the two batteries can be charged in parallel. In the charging process of the electric circuit of this type, the degradation of a degraded battery progresses when a high current flows through the battery. In the present specification, there is proposed a technique capable of efficiently charging a battery while suppressing degradation of the battery.

An aspect of the present specification discloses an electric circuit mounted on a vehicle. The electric circuit includes a first battery, a second battery, a three-phase motor, an inverter circuit, a charging socket, a connection switching circuit, and a control circuit. The three-phase motor includes three windings of a U-phase winding, a V-phase winding, and a W-phase winding. Each of the three windings includes a first connection terminal provided at one end of the winding and a second connection terminal provided at the other end of the winding. The second connection terminals of the three windings are connected to each other at a neutral point. The inverter circuit is connected to the first connection terminal of the U-phase winding, the first connection terminal of the V-phase winding, and the first connection terminal of the W-phase winding. The charging socket includes a high potential charging terminal and a low potential charging terminal, and is connected to a charging facility external to the vehicle. The connection switching circuit changes a connection relationship among the first battery, the second battery, the inverter circuit, the neutral point, and the charging socket. The inverter circuit includes a high potential wiring, a low potential wiring, and three series switch circuits provided for each of the three windings. Each of the series switch circuits includes an upper reverse conduction switching element that is a reverse conduction switching element connected between the first connection terminal of the corresponding winding and the high potential wiring, and a lower reverse conduction switching element that is a reverse conduction switching element connected between the first connection terminal of the corresponding winding and the low potential wiring. The control circuit is able to control the connection switching circuit to a charging mode in which a positive electrode of the first battery and the high potential wiring are connected to the high potential charging terminal by the connection switching circuit, a negative electrode of the first battery, a negative electrode of the second battery, and the low potential wiring are connected to the low potential charging terminal by the connection switching circuit, and a positive electrode of the second battery is connected to the neutral point by the connection switching circuit. When the first battery and the second battery are charged by the charging socket, the control circuit executes a degradation determination process, a first charging process, and a second charging process. In the degradation determination process, the control circuit determines degradation of at least one of the first battery and the second battery. In the first charging process, the control circuit selectively executes step-down charging operation and direct charging operation when it is determined that there is no degradation in the degradation determination process, such that the step-down charging operation is executed when an output voltage difference obtained by subtracting an output voltage of the second battery from an output voltage of the first battery is more than a reference value, and the direct charging operation is executed when the output voltage difference is less than the reference value. In the second charging process, the control circuit executes the step-down charging operation regardless of the output voltage difference when it is determined that there is degradation in the degradation determination process. The step-down charging operation is operation to repeatedly switch at least one of the three upper reverse conduction switching elements while controlling the three lower reverse conduction switching elements off in the charging mode. The direct charging operation is operation to maintain at least one of the three upper reverse conduction switching elements on while controlling the three lower reverse conduction switching elements off in the charging mode.

In this specification, the reverse conduction switching element means an element in which a switching element and a diode are connected in parallel. Specifically, the reverse conduction switching element means an element in which a cathode of the diode is connected to a high potential-side terminal of the switching element and an anode of the diode is connected to a low potential-side terminal of the switching element. The switching element may be a semiconductor switching element such as a field effect transistor or an insulated gate bipolar transistor. The diode may be a pn diode, or may be a Schottky barrier diode. Further, the switching element and the diode may be provided on a common semiconductor substrate, or may be provided on separate semiconductor substrates. In the present specification, it is meant that the switching element included in the reverse conduction switching element is on when the reverse conduction switching element is on, and it is meant that the switching element included in the reverse conduction switching element is off when the reverse conduction switching element is off.

In the degradation determination process, degradation of one of the first battery and the second battery may be determined, or degradation of both the first battery and the second battery may be determined.

In this electric circuit, the control circuit executes the first charging process when it is determined that the battery is not degraded. In the first charging process, the control circuit selectively executes the step-down charging operation and the direct charging operation according to the output voltage difference. In the step-down charging operation, the generation of an excessive current can be suppressed, while the charging current for the second battery is lowered. In the direct charging operation, an excessive current may be generated when the output voltage difference is large, while the second battery can be charged by a high charging current. In the first charging process, the step-down charging operation and the direct charging operation are selectively executed according to the output voltage difference, and thus the first battery and the second battery can be efficiently charged while suppressing an excessive current. In addition, the control circuit executes the second charging process when it is determined that the battery is degraded. In the second charging process, the step-down charging operation is executed regardless of the output voltage difference. Thus, the current flowing through the first battery and the second battery can be further reduced, and degradation of the first battery and the second battery can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a circuit diagram of an electric circuit according to an embodiment (a circuit diagram showing a current path when the upper reverse conduction switching element 35VU is on);

FIG. 2 is a flowchart of charge control; FIG. 3 is a flowchart of a first charging process;

FIG. 4 is a circuit diagram of the electric circuit of the embodiment (a circuit diagram showing a current path when the upper reverse conduction switching element 35VU is turned off during the step-down charging operation); and

FIG. 5 is a flowchart of a second charging process.

### DETAILED DESCRIPTION OF EMBODIMENTS

In an example electric circuit disclosed in this specification, the control circuit may perform a one-side charging operation of charging the first battery without charging the second battery when an output voltage of the first battery is smaller than an output voltage of the second battery before the first charging process and the second charging process are started.

In the example electric circuit disclosed in this specification, the control circuit may determine that the first battery is deteriorated in the deterioration determination process when the output voltage of the first battery is lower than the output voltage of the second battery.

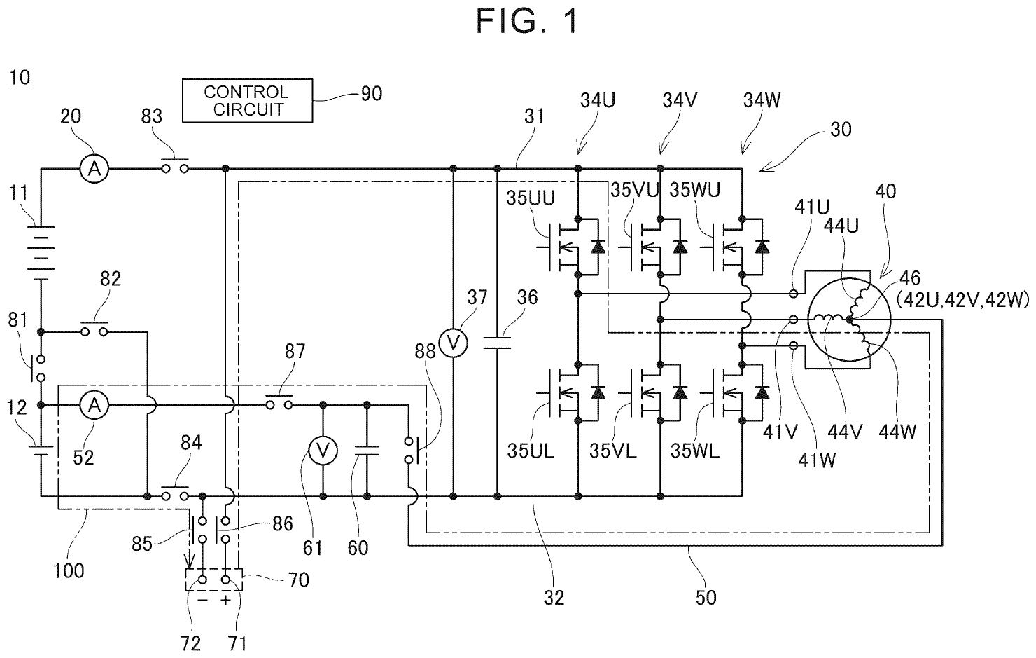

The electric circuit 10 shown in FIG. 1 is mounted on a vehicle. The electric circuit 10 includes a first battery 11, a second battery 12, an inverter circuit 30, and a three-phase motor 40. The three-phase motor 40 is a driving motor of the vehicle. The inverter circuit 30 converts the DC power supplied from the first battery 11 and the second battery 12 into AC power and supplies the AC power to the three-phase motor 40. As a result, the three-phase motor 40 rotates the drive wheels, and the vehicle travels. 15

The three-phase motor 40 has a U-phase winding 44U, a V-phase winding 44V, and a W-phase winding 44W. Terminal 41U and terminal 42U are provided at both ends of the winding 44U. Terminal 41V and terminal 42V are provided at both ends of the winding 44V. Terminal 41W and terminal 42W are provided at both ends of the winding 44W. The terminals 42U, 42V, 42W are connected to each other at a neutral point 46. 20

The inverter circuit 30 is connected to the terminal 41U, 41V, 41W of the three-phase motor 40. The inverter circuit 30 includes a high-potential wiring 31, a low-potential wiring 32, and three series switching circuits 34U, 34V, 34W. Each of the series switching circuits 34U, 34V, 34W includes two reverse conduction switching elements 35 25 connected in series between the high-potential wiring 31 and the low-potential wiring 32. In the following description, of the two reverse conduction switching elements 35 connected in series, the one connected to the high potential wiring 31 is referred to as an upper reverse conduction switching element, and the one connected to the low potential wiring 32 is referred to as a lower reverse conduction switching element. The reverse conduction 30 switching elements 35 have a configuration in which switching elements (for example, insulated gate bipolar transistors or field-effect transistors) and diodes (for example, pn diodes or Schottky barrier diodes) are connected in anti-parallel. In each reverse conduction switching element 35, the cathode of the diode is connected to the high potential terminal (i.e., collector or drain) of the switching element and the anode of the diode is connected to the low potential terminal (i.e., emitter or source) of the switching element.

The series switching circuit 34U is provided for the winding 44U. The series switching circuit 34U has an upper reverse conduction switching element 35UU and a lower reverse conduction switching element 35UL. The high potential terminal of the upper reverse conduction switching element 35UU is connected to the high potential wiring 31. The low potential terminal of the upper reverse conduction switching element 35UU and the high potential terminal of the lower reverse conduction switching element 35UL are connected to the terminal 41U. The low potential terminal of the lower reverse conduction switching element 35UL is connected to the low potential wiring 32.

The series switching circuit 34V is provided for the winding 44V. The series switching circuit 34V has an upper reverse conduction switching element 35VU and a lower reverse conduction switching element 35VL. The high potential terminal of the upper reverse conduction switching element 35VU is connected to the high potential wiring 31. The low potential terminal of the upper reverse conduction switching element 35VU and the high potential terminal of the lower reverse conduction switching element 35VL are connected to the terminal 41V. The low potential terminal of the lower reverse conduction switching element 35VL is connected to the low potential wiring 32.

The series switching circuit 34W is provided for the winding 44W. The series switching circuit 34W has an upper reverse conduction switching element 35WU and a lower reverse conduction switching element 35WL. The high potential terminal of the upper reverse conduction switching element 35WU is connected to the high potential wiring 31. The low potential terminal of the upper reverse conduction switching element 35WU and the high potential terminal of the lower reverse conduction switching element 35WL are connected to the terminal 41W. The low potential terminal of the lower reverse conduction switching element 35WL is connected to the low potential wiring 32.

A capacitor 36 is connected between the high-potential wiring 31 and the low-potential wiring 32. A voltmeter 37 is connected between the high-potential wiring 31 and the low-potential wiring 32.

A neutral point wiring 50 is connected to the neutral point 46 of the three-phase motor 40. A capacitor 60 is connected between the neutral point wiring 50 and the low potential wiring 32. A voltmeter 61 is connected between the neutral point wiring 50 and the low-potential wiring 32.

The electric circuit 10 has a charging socket 70. A connector of a charging facility outside the vehicle can be connected to the charging socket 70. The charging socket 70 has a high potential charging terminal 71 and a low potential charging terminal 72. When the connector of the charging facility is connected to the charging socket 70, a DC voltage is applied between the high-potential charging terminal 71 and the low-potential charging terminal 72 by the charging facility in a direction in which the high-potential charging terminal 71 becomes a high potential.

The electric circuit 10 includes a plurality of relay switches 81 to 88. When the relay switches are switched, the connection relationship between the first battery 11, the second battery 12, the high-potential wiring 31, the low-potential wiring 32, the neutral point 46, and the charging socket 70 is changed.

The relay switch 81 is provided between the negative electrode of the first battery 11 and the positive electrode of the second battery 12. When the relay switch 81 is turned on, the first battery 11 and the second battery 12 are connected in series.

The relay switch 82 is provided between the negative electrode of the first battery 11 and the negative electrode of the second battery 12. When the relay switch 82 is turned on, the negative electrode of the first battery 11 and the negative electrode of the second battery 12 are connected.

An ammeter 20 and a relay switch 83 are provided in series between the positive electrode of the first battery 11 and the high-potential wiring 31. When the relay switch 83 is turned on, the positive electrode of the first battery 11 is connected to the high potential wiring 31.

The relay switch 84 is provided between the negative electrode of the second battery 12 and the low-potential wiring 32. When the relay switch 84 is turned on, the negative electrode of the second battery 12 is connected to the low potential wiring 32.

The relay switch 85 is provided between the low-potential charging terminal 72 and the low-potential wiring 32. When the relay switch 85 is turned on, the low-potential charging terminal 72 is connected to the low-potential wiring 32.

The relay switch 86 is provided between the high-potential charging terminal 71 and the high-potential wiring 31. When the relay switch 86 is turned on, the high-potential charging terminal 71 is connected to the high-potential wiring 31.

An ammeter 52 and a relay switch 87 are provided in series between the positive electrode of the second battery 12 and the neutral point wiring 50. Further, a relay switch 88 is provided in the neutral point wiring 50. When the relay switches 87 and 88 are turned on, the positive electrode of the second battery 12 is connected to the neutral point 46.

The electric circuit 10 includes a control circuit 90. The control circuit 90 includes CPU, memories, and the like. A program for controlling the electric circuit 10 is stored in the memory of the control circuit 90. The control circuit 90 controls the switching elements of the reverse conduction switching elements 35 and the relay switches 81 to 88 in accordance with the program. The control circuit 90 can perform normal control and charge control.

In the normal control, the control circuit 90 turns on the relay switches 81, 83, and 84 and turns off the relay switches 82, 85, 86, 87, and 88. In this state, the first battery 11 and the second battery 12 are connected in series between the high-potential wiring 31 and the low-potential wiring 32. Therefore, the DC voltage output from the series circuit of the first battery 11 and the second battery 12 is applied between the high-potential wiring 31 and the low-potential wiring 32. The control circuit 90 switches the switching elements of the reverse conduction switching elements 35 to convert the DC power applied between the high-potential wiring 31 and the low-potential wiring 32 into AC power, and supplies the AC power to the three-phase motor 40. This causes the three-phase motor 40 to rotate. The control circuit 90 controls the torque and the rotation speed of the three-phase motor 40 by changing the amplitude, frequency, and the like of the alternating current supplied to the three-phase motor 40.

In the charge control, the control circuit 90 executes a charge control program to charge the first battery 11 and the second battery 12. When an external charging facility is connected to the charging socket 70, the control circuit 90 starts charging control.

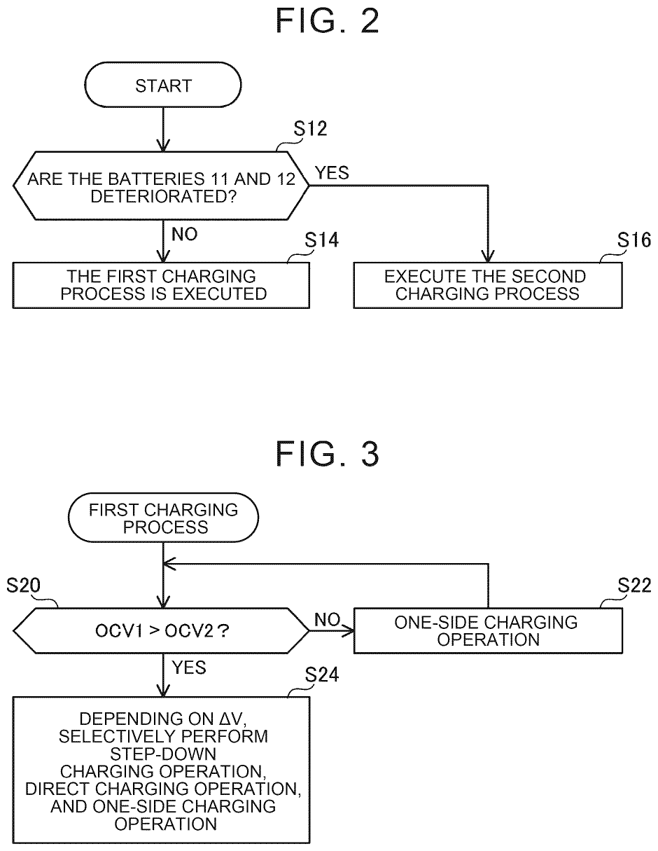

As illustrated in FIG. 2, when the charge control is started, the control circuit 90 determines the degradation of the batteries 11 and 12 in S12. Determination of deterioration of the batteries 11 and 12 can be performed by various methods known in the art. For example, degradation of the batteries 11, 12 may be determined from a previous history of SOC (State Of Charge) or OCV (Open Circuit Voltage) of the batteries 11, 12. When the first battery 11 is deteriorated, OCV of the first battery 11 may be lower than OCV of the second battery 12. When the relay switches 82, 83, 87, and 88 are turned on while all the reverse conduction switching elements 35 are turned off, a current (hereinafter referred to as a leakage current) flows from the positive electrode of the second battery 12 to the positive electrode of the first battery 11 via the neutral point wiring 50, the winding 44U to 44W, the diode of the upper reverse conduction switching element 35UU, 35VU, 35WU, and the high potential wiring 31. When the first battery 11 is not deteriorated (that is, when OCV of the first battery 11 is higher than OCV of the second battery 12), no leakage current flows. Therefore, the deterioration of the first battery 11 may be determined by detecting whether or not a leakage current flows by the ammeter 20 or 52.

When neither the first battery 11 nor the second battery 12 has deteriorated, the control circuit 90 executes the first charge process in S14. When degradation occurs in at least one of the first battery 11 and the second battery 12, the control circuit 90 executes the second charge process in S16.

FIG. 3 shows a first charging process. In the first charge process, the control circuit 90 first determines whether or not OCV of the first battery 11 (hereinafter, referred to as OCV1) is larger than OCV of the second battery 12 (hereinafter, referred to as OCV2) in S20. OCV1 of the first battery 11 may be measured by the voltmeter 37 by turning on the relay switches 82, 83, and 84 while the relay switches 85 and 86 are turned off. Further, OCV2 of the second battery 12 may be measured by the voltmeter 61 by turning on the relay switches 84 and 87 while the relay switches 85 and 86 are turned off. Further, it may be determined whether or not OCV1 is larger than OCV2 by detecting the leakage current. When the charging current is supplied from an external charging facility, it is difficult to directly measure OCV1 and OCV2. In this instance, OCV1 and OCV2 may be calculated instead of directly measuring OCV1 and OCV2. Further, the charging current supplied from an external charging facility may be reduced, CCV (Closed Circuit Voltage) of the batteries 11 and 12 may be measured under a small current condition, and the measured CCV may be regarded as a OCV1, OCV2 in a pseudo manner.

When OCV1 is smaller than OCV2, the control circuit 90 performs the one-side charge operation in S22. The one-side charging operation is an operation of charging the first battery 11 without charging the second battery 12. In the one-side charging operation, the control circuit 90 turns on the relay switches 82 to 86 and turns off the relay switches 81, 87, and 88. Then, the positive electrode of the first battery 11 is connected to the high- potential charging terminal 71 via the relay switches 83 and 86, and the negative electrode of the first battery 11 is connected to the low-potential charging terminal 72 via the relay switches 82, 84, and 85. Therefore, the output voltage of the external charging facility is applied to the first battery 11, and the first battery 11 is charged. Since the positive electrode of the second battery 12 is suspended by turning off the relay switches 81 and 87, the second battery 12 is not charged. Therefore, the first battery 11 is charged without the second battery 12 being charged.

By repeating S20 and S22, the control circuit 90 charges the first battery 11 until OCV1 becomes higher than OCV2. When OCV1 becomes higher than OCV2, the control circuit 90 determines YES in S20 and executes S24.

In S24, the control circuit 90 charges the batteries 11, 12 in an operating manner responsive to OCV1 and OCV2. Since OCV1 and OCV2 change during charging of the battery 11 and the battery 12, the control circuit 90 changes the operation methods during charging. Hereinafter, S24 will be described in detail.

In S24, the control circuit 90 periodically detects OCV1 and OCV2. OCV1 and OCV2 can be detected by any of the methods described in S20. Further, the control circuit 90 calculates a voltage difference ΔV (ΔV=OCV1−OCV2) obtained by subtracting OCV2 from OCV1. When the voltage difference ΔV is higher than the reference value ΔVth, the control circuit 90 executes the step-down charging operation. When the voltage difference ΔV is lower than the reference value ΔVth and higher than 0V, the control circuit 90 performs the direct charge operation. When the voltage difference ΔV is lower than 0V, the control circuit 90 performs the one-side charge operation. The step-down charging operation is an operation of charging the first battery 11 and the second battery 12 in parallel, and is an operation of charging the second battery 12 at a relatively low voltage. The direct charging operation is an operation of charging the first battery 11 and the second battery 12 in parallel, and is an operation of charging the second battery 12 at a higher voltage than the step-down charging operation. The one-side charging operation is an operation of charging the first battery 11 without charging the second battery 12.

In the step-down charging operation, the control circuit 90 turns on the relay switches 82 to 88 and turns off the relay switch 81. Hereinafter, this control state may be referred to as a charging mode. In the charging mode, the positive electrode of the first battery 11 and the high-potential wiring 31 are connected to the high-potential charging terminal 71. In the charging mode, the negative electrode of the first battery 11, the negative electrode of the second battery 12, and the low-potential wiring 32 are connected to the low-potential charging terminal 72. In the charging mode, the positive electrode of the second battery 12 is connected to the neutral point 46. In the step-down charge operation, the control circuit 90 turns off the lower reverse conduction switching elements 35UL, 35VL, 35WL. In the step-down charging operation, the control circuit 90 repeatedly switches at least one of the upper reverse conduction switching elements 35UU, 35VU, 35WU (hereinafter referred to as a “specified switching element”). When an element other than the specific switching element is present in the upper reverse conduction switching elements 35UU, 35VU, 35WU, the control circuit 90 keeps the element other than the specific switching element off. Hereinafter, a current path when the upper reverse conduction switching element 35VU is a particular switching element will be described.

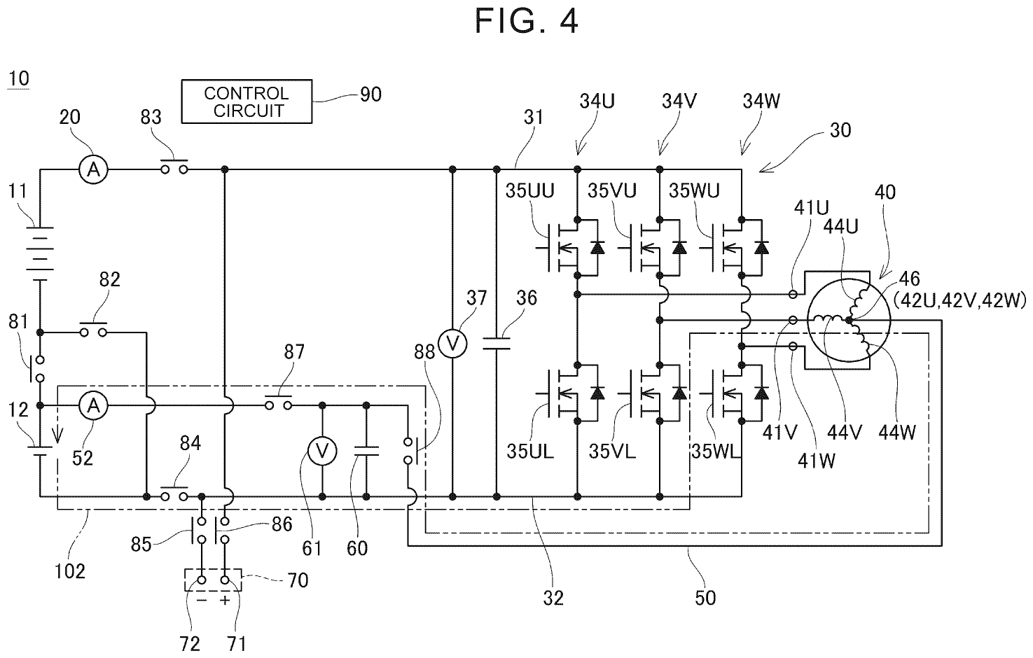

As described above, in the step-down charging operation, the positive electrode of the first battery 11 is connected to the high-potential charging terminal 71, and the negative electrode of the first battery 11 is connected to the low-potential charging terminal 72. Therefore, the output voltage of the external charging facility is applied to the first battery 11, and the first battery 11 is charged. Further, as described above, in the step-down charging operation, the high potential wiring 31 is connected to the high potential charging terminal 71, the low potential wiring 32 is connected to the low potential charging terminal 72, the positive electrode of the second battery 12 is connected to the neutral point 46, and the negative electrode of the second battery 12 is connected to the low potential charging terminal 72. In this condition, when the upper reverse conduction switching element 35VU (i.e., the particular switching element) is turned on, as indicated by arrow 100 in FIG. 1, a current flows from the high potential charging terminal 71 to the low potential charging terminal 72 via the high potential wiring 31, the upper reverse conduction switching element 35VU, the winding 44V, the neutral point wiring 50, and the second battery 12. Thereafter, when the upper reverse conduction switching element 35VU is turned off, an induced electromotive force is generated in the winding 44V. Consequently, as indicated by arrow 102 in FIG. 4, a return current flows through the diode of the lower reverse conduction switching element 35VL, the winding 44V, and the second battery 12. In the step-down operation, current flows alternately in the paths indicated by arrows 100 and 102, so that the second battery 12 is charged. As described above, in the step-down operation, the windings of the inverter circuit 30 and the three-phase motor 40 function as the step-down converter circuit. Therefore, a voltage lower than the output voltage of the external charging facility is applied to the second battery 12, and the second battery 12 is charged with a low charging current.

In the direct charging operation, the control circuit 90 controls the relay switches 81 to 88 to the charging mode. In the direct charge operation, the control circuit 90 turns off the lower reverse conduction switching elements 35UL, 35VL, 35WL. Further, in the direct charge operation, the control circuit 90 maintains a particular switching element of the upper reverse conduction switching elements 35UU, 35VU, 35WU on. When an element other than the specific switching element is present in the upper reverse conduction switching elements 35UU, 35VU, 35WU, the control circuit 90 keeps the element other than the specific switching element off. Hereinafter, a current path when the upper reverse conduction switching element 35VU is a particular switching element will be described.

In the direct charging operation, as in the step-down charging operation, an output voltage of an external charging facility is applied to the first battery 11, and the first battery 11 is charged. Further, in the direct charging operation, since the upper reverse conduction switching element 35VU is constantly turned on, a direct current flows in a path indicated by an arrow 100 in FIG. 1 to charge the second battery 12. In the direct charging operation, since the specific switching element is always on, the output voltage of the external charging facility is applied to the second battery 12 without being stepped down. Therefore, in the direct charging operation, the second battery 12 is charged with a charging current higher than that in the step-down charging operation.

When the charging operation is directly performed in a state in which the voltage difference ΔV is large (that is, in a state in which the output voltage of the first battery 11 is much higher than the output voltage of the second battery 12), the output voltage of the first battery 11 is applied to the second battery 12, and an excessive current flows from the first battery 11 to the second battery 12. As a result, a high load is applied to the batteries 11 and 12. On the other hand, in the first charging process, the step-down charging operation is executed in a state where the voltage difference ΔV is large, and an excessive current is suppressed from flowing from the first battery 11 to the second battery 12. Accordingly, the load applied to the batteries 11 and 12 is reduced. Further, in the first charging process, in a state where the voltage difference ΔV is not so large, there is no possibility that an excessive current flows, and therefore, the charging operation is directly performed. Accordingly, the second battery 12 is efficiently charged.

When ΔV<0 (i.e., OCV1<OCV2) is satisfied in S24, the control circuit 90 executes the one-side charge operation. The one-sided charging operation performed in S24 is equal to the one-sided charging operation performed in S22. When OCV2 is increased until ΔV<0 by the direct charging operation, OCV1, OCV2 is adjusted so that ΔV>0 by the one-side charging operation.

As described above, in the first charging process, the step-down charging operation, the direct charging operation, and the one-side charging operation are selectively executed in accordance with ΔV. Accordingly, it is possible to efficiently charge the second battery 12 while suppressing generation of an excessive current.

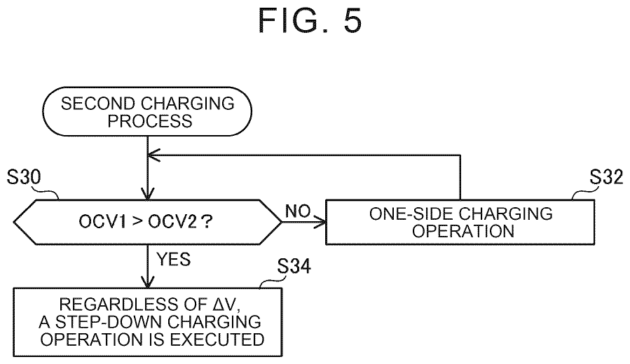

Next, the second charging process will be described. As described above, when degradation occurs in at least one of the first battery 11 and the second battery 12, the control circuit 90 executes the second charge process in S16. FIG. 5 shows a second charging process. S30, S32 of the second charging process is equal to S20, S22 of the first charging process. That is, in S30, S32, OCV1, OCV2 is adjusted so as to be OCV1>OCV2. Thereafter, the control circuit 90 performs a step-down charging operation in S34, and charges the batteries 11 and 12. The step-down charging operation performed by S34 is equal to the step-down charging operation performed by S24. In S34, the control circuit 90 performs the step-down charge operation regardless of the voltage difference ΔV. In this way, when deterioration occurs in at least one of the first battery 11 and the second battery 12, the direct charging operation is prohibited and the step-down charging operation is executed. Accordingly, a high current is suppressed from flowing from the first battery 11 to the second battery 12, and further deterioration of the batteries 11 and 12 is suppressed.

As described above, in the electric circuit 10 of the present embodiment, when the batteries 11 and 12 are not deteriorated, the direct charging operation is permitted in S24, and the second battery 12 is efficiently charged. In addition, when deterioration occurs in the batteries 11 and 12, direct charge operation is prohibited in S34, and further deterioration of the batteries 11 and 12 is suppressed.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of 10 objectives at the same time, and achieving one of the objectives itself has technical usefulness.

What is claimed is:

1. An electric circuit mounted on a vehicle, comprising:
a first battery;
a second battery;
a three-phase motor including three windings of a U-phase winding, a V-phase winding, and a W-phase winding, each of the three windings including a first connection terminal provided at one end of the winding and a second connection terminal provided at the other end of the winding, and the second connection terminals of the three windings being connected to each other at a neutral point;
an inverter circuit connected to the first connection terminal of the U-phase winding, the first connection terminal of the V-phase winding, and the first connection terminal of the W-phase winding;
a charging socket including a high potential charging terminal and a low potential charging terminal and connected to a charging facility external to the vehicle;
a connection switching circuit that changes a connection relationship among the first battery, the second battery, the inverter circuit, the neutral point, and the charging socket; and
a control circuit, wherein:
the inverter circuit includes
a high potential wiring,
a low potential wiring, and
three series switch circuits provided for each of the three windings;
each of the series switch circuits includes an upper reverse conduction switching element that is a reverse conduction switching element connected between the first connection terminal of the corresponding winding and the high potential wiring, and a lower reverse conduction switching element that is a reverse conduction switching element connected between the first connection terminal of the corresponding winding and the low potential wiring;
the control circuit is able to control the connection switching circuit to a charging mode in which a positive electrode of the first battery and the high potential wiring are connected to the high potential charging terminal by the connection switching circuit, a negative electrode of the first battery, a negative electrode of the second battery, and the low potential wiring are connected to the low potential charging terminal by the connection switching circuit, and a positive electrode of the second battery is connected to the neutral point by the connection switching circuit;
when the first battery and the second battery are charged by the charging socket, the control circuit executes
a degradation determination process of determining degradation of at least one of the first battery and the second battery,
a first charging process of selectively executing step-down charging operation and direct charging operation when it is determined that there is no degradation in the degradation determination process, such that the step-down charging operation is executed when an output voltage difference obtained by subtracting an output voltage of the second battery from an output voltage of the first battery is more than a reference value, and the direct charging operation is executed when the output voltage difference is less than the reference value, and
a second charging process of executing the step-down charging operation regardless of the output voltage difference when it is determined that there is degradation in the degradation determination process;
the step-down charging operation is operation to repeatedly switch at least one of the three upper reverse conduction switching elements while controlling the three lower reverse conduction switching elements off in the charging mode; and
the direct charging operation is operation to maintain at least one of the three upper reverse conduction switching elements on while controlling the three lower reverse conduction switching elements off in the charging mode.

2. The electric circuit according to claim 1, wherein the control circuit executes one-side charging operation to charge the first battery without charging the second battery when the output voltage of the first battery is lower than the output voltage of the second battery before start of the first charging process and the second charging process.

3. The electric circuit according to claim 1, wherein the control circuit determines that the first battery is degraded when the output voltage of the first battery is lower than the output voltage of the second battery in the degradation determination process.

4. A non-transitory storage medium storing a program that causes an electric circuit mounted on a vehicle to execute a charging process, the electric circuit including:
a first battery;
a second battery;
a three-phase motor including three windings of a U-phase winding, a V-phase winding, and a W-phase winding, each of the three windings including a first connection terminal provided at one end of the winding and a second connection terminal provided at the other end of the winding, and the second connection terminals of the three windings being connected to each other at a neutral point;
an inverter circuit connected to the first connection terminal of the U-phase winding, the first connection terminal of the V-phase winding, and the first connection terminal of the W-phase winding;
a charging socket including a high potential charging terminal and a low potential charging terminal and connected to a charging facility external to the vehicle;
a connection switching circuit that changes a connection relationship among the first battery, the second battery, the inverter circuit, the neutral point, and the charging socket; and
a control circuit, wherein:
the inverter circuit includes
a high potential wiring,
a low potential wiring, and
three series switch circuits provided for each of the three windings;
each of the series switch circuits includes an upper reverse conduction switching element that is a reverse conduction switching element connected between the first connection terminal of the corresponding winding and the high potential wiring, and a lower reverse conduction switching element that is a reverse conduction switching element connected between the first connection terminal of the corresponding winding and the low potential wiring;
the program is able to cause the control circuit to execute a charging mode;
the charging mode is a mode in which a positive electrode of the first battery and the high potential wiring are connected to the high potential charging terminal by the connection switching circuit, a negative electrode of the first battery, a negative electrode of the second battery, and the low potential wiring are connected to the low potential charging terminal by the connection switching circuit, and a positive electrode of the second battery is connected to the neutral point by the connection switching circuit;
when the first battery and the second battery are charged by the charging socket, the program causes the control circuit to execute
a degradation determination process of determining degradation of at least one of
the first battery and the second battery, a first charging process of selectively executing step-down charging operation and direct charging operation when it is determined that there is no degradation in the degradation determination process, such that the step-down charging operation is executed when an output voltage difference obtained by subtracting an output voltage of the second battery from an output voltage of the first battery is more than a reference value, and the direct charging operation is executed when the output voltage difference is less than the reference value, and
a second charging process of executing the step-down charging operation regardless of the output voltage difference when it is determined that there is degradation in the degradation determination process;
the step-down charging operation is operation to repeatedly switch at least one of the three upper reverse conduction switching elements while controlling the three lower reverse conduction switching elements off in the charging mode; and
the direct charging operation is operation to maintain at least one of the three upper reverse conduction switching elements on while controlling the three lower reverse conduction switching elements off in the charging mode.
